(19) United States
(12) Patent Application Publication
(10) Pub. No.: US 2003/0012929 A1
(43) Pub. Date: Jan. 16, 2003

(54) Shock absorbing and slip resistant pad

(76) Inventor: Tai-Yuan Tsai, Taipei Hsien (TW)

Correspondence Address: Beehler & Pavitt, Suite 330, 100 Corporate Pointe, Culver City, CA, 90230, US

(21) Appl. No.: 09/907,100

(22) Filed: Jul. 16, 2001

(51) Int. Cl. B32B 3/26

(52) U.S. Cl. 428/150

(57) ABSTRACT

A shock absorbing and slip resistant pad made of a foam material that has a resilient texture and a sufficient depth to absorb shock. The pad has a slip resistant surface and an engaging surface. The slip-resistant surface has sand evenly distributed therealong to form a rough surface for slip resistance. The engaging surface has an adhesive substance applied thereon to adhere the pad to the skateboard. A pattern is stenciled and color printed on the slip resistant surface for a decorative or a commercial effect.

### BACKGROUND OF THE INVENTION

1. Field of the Invention

The present invention relates to a pad, and more particularly to a shock absorbing and slip resistant pad that has a resilient texture to absorb shock and a rough surface for slip resistance.

2. Description of Related Art

People today are becoming more and more concerned about their health and living conditions. Accordingly, all kinds of leisure and sport activities have become increasingly popular and equipment used in these activities has correspondingly improved. A major objective in improving the equipment is to provide safe equipment to prevent injuries in performing the activities.

Skateboards are commonly seen and used as an extreme sport vehicle. A conventional skateboard has a smooth top surface on which a rider places a foot. However, it is easy for a foot to slip on the smooth top surface. Moreover, rigidity of the smooth top surface can not provide a shock absorbing effect. The shortcomings of a lack of sure foothold and lack of shock absorbency are serious and may not only effect the performance of the skateboard but also may cause injury of the rider.

To overcome the shortcomings, the present invention tends to provide a shock absorbing and slip resistant pad to mitigate or obviate the aforementioned problems.

### SUMMARY OF THE INVENTION

The objective of the present invention is to provide a shock absorbing and slip resistant pad that has a resilient texture and a substantial depth to absorb shock when applied onto a surface.

Another objective of the present invention is to provide a shock absorbing and slip resistant pad that has a slip resistant surface. The slip resistant surface has sand distributed therealong to increase the roughness of the slip resistant surface.

Another objective of the present invention is to provide a shock absorbing and slip resistant pad that has a pattern formed thereon in order to be decorative and to provide commercial effect.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart showing a construction of a shock absorbing and slip resistant pad in accordance with the present invention;

FIG. 2 is an exploded, perspective view of a preferred embodiment of the pad;

FIG. 3 is a perspective view of the preferred embodiment; and

FIG. 4 is a cross-sectional view of the preferred embodiment taken along the line 4-4 of FIG. 3.

### DETAILED DESCRIPTION OF THE PREFERRED EMBODIMENT

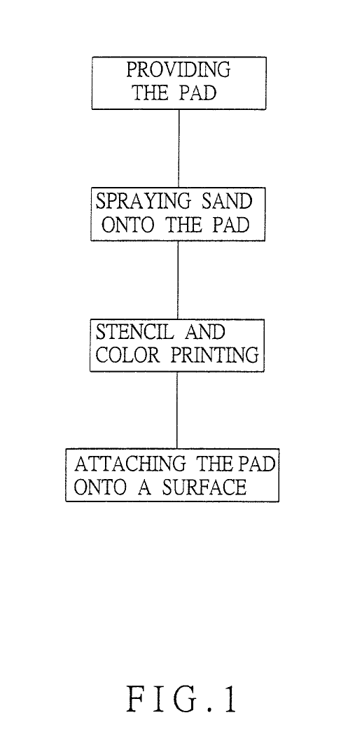

With reference to FIG. 1, a shock absorbing and slip resistant pad in accordance with the present invention is shown, wherein the pad is constructed using the following steps:

1. providing the pad: The pad is provided with a foam material. The foam material has a resilient texture and a sufficient depth in order to be shock absorbing.

2. spraying sand onto the pad: A top surface of the pad is applied with an adhesive substance. Sand is then evenly distributed over the now-adhesive top surface and the sand adheres to the top surface to increase the roughness of the top surface for slip resistance.

3. stencil and color printing: The pad is stenciled and color printed with a desired pattern or picture for decorative or commercial purpose. Hot pressing can be applied as a preferred method to stencil a 3-dimensional pattern or a picture onto the top surface of the pad.

4. attaching the pad onto a surface: The pad that undergoes the foregoing steps is attached to a surface of a skateboard.

The pad is made of the foam material such as polyethylene or polyacetate, and has a preferred depth of 0.3 mm˜10 mm. With this preferred depth, the pad is thick enough to provide a good shock absorbing effect and the pattern or the picture can be stenciled in a 3-dimensional form.

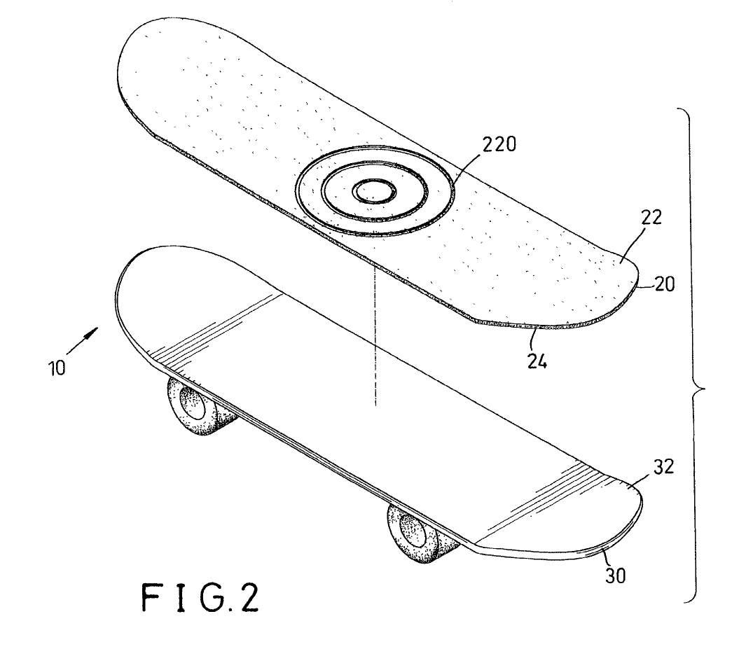

With reference to FIG. 2, the pad (20) is applied onto a skate board (10). The pad (20) is cut according to a plane configuration of a platform (30) of the skate board (10). The pad (20) has a slip resistant surface (22) for a player to step on and an engaging surface (24) to attach with a top surface (32) of the platform (30). The slip resistant surface (22) is applied with the adhesive substance and then sand is evenly and securely distributed along the now-adhesive resistant surface (22). The sand increases the roughness of the slip resistant surface (22) and thus provides a highly slip-resistant effect of the pad (20). A pattern (220) is stenciled onto the slip resistant surface (22) and color printed. A hot pressing method can be used when stenciling the resistant surface (22) to form the pattern (220) with a 3-dimensional configuration.

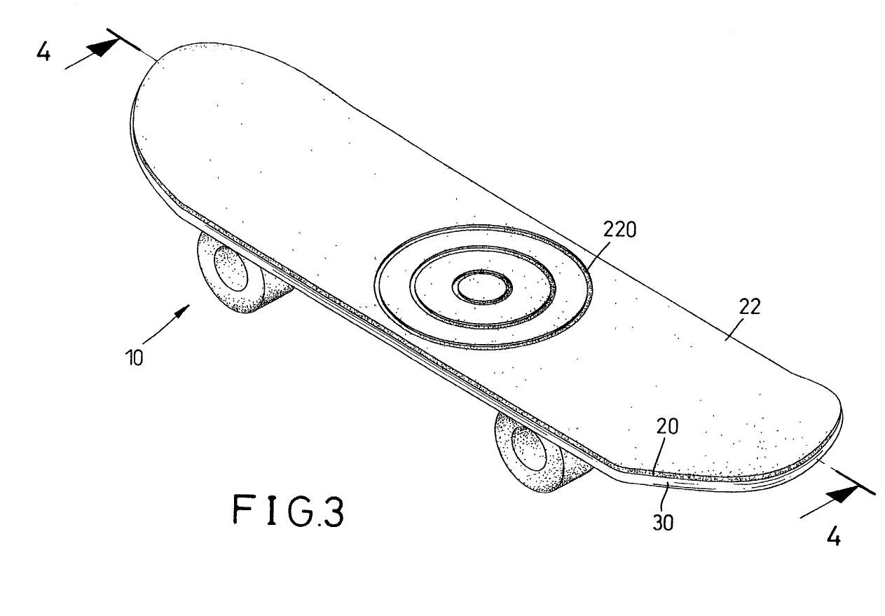

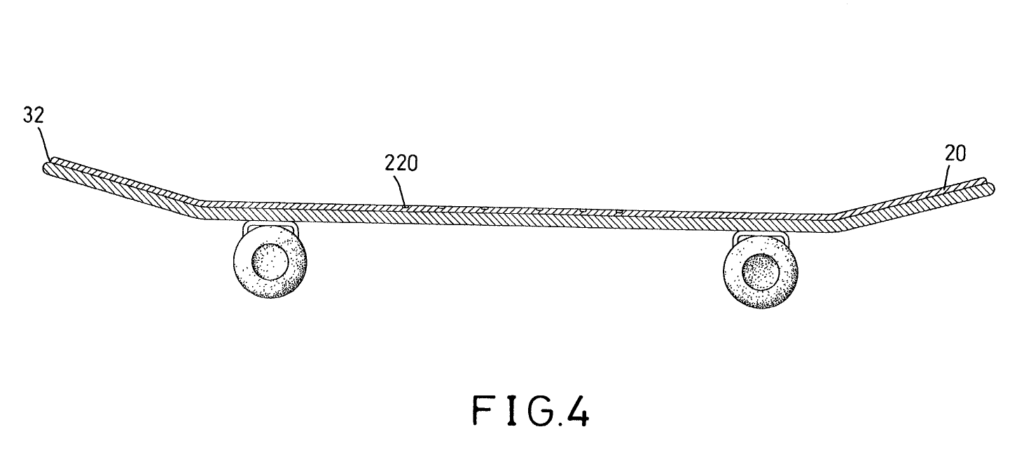

With reference to FIGS. 3 and 4, the pad (20) and the skate board (10) are attached together by an adhesive attachment between the engaging surface (24) and the top surface (32) of the platform (30) of the skate board (10). When in operation, the pad (20) attached on the skate board (10) can absorb shock due to the resilience of the pad (20) and the roughness of the slip resistant surface (22) can resist slipping of a foot of the rider against the skate board (10). The pad (20) having the pattern (220) that can be 3-dimensional and colorful is able to enhance an aesthetic appearance of the skate board (10). Additionally, the pattern (220) can be formed as a trademark, a logo, or anything that can provide a commercial effect.

From the above description, it is noted that the invention has the following advantages:

1. The pad (20) has a resilient texture to absorb shock.

2. The pad (20) has a rough surface to prevent slipping.

3. The pad (20) can be formed with pattern (220) in order to be decorative or provide commercial effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shock absorbing and slip resistant pad comprising:
a foaming material having a resilient texture to absorb shock;
a slip resistant surface formed on the foaming material, the slip resistant surface having sand evenly distributed therealong to form a rough surface for slip resistance; and
an engaging surface formed on the foaming material opposite to the slip resistant surface, the engaging surface having an adhesive substance applied thereon,
whereby the engaging surface is suitable for adhering to a skateboard and the foaming material absorbs shock due to the resilient texture and the engaging surface resists slipping due to the rough surface.

2. The shock absorbing and slip resistant pad as claimed in claim 1, wherein the slip resistant surface further comprises a pattern formed on the slip resistant surface for a decorative effect.
